(19) United States
(12) Patent Application Publication
(10) Pub. No.: US 2021/0333961 A1
(43) Pub. Date: Oct. 28, 2021

(54) Temporarily Extending Display Timeout

(71) Applicant: Motorola Mobility LLC, Chicago, IL (US)

(72) Inventor: Xiaofeng Zhu, Nanjing (CN)

(73) Assignee: Motorola Mobility LLC, Chicago, IL (US)

(21) Appl. No.: 16/875,436

(22) Filed: May 15, 2020

(30) Foreign Application Priority Data
Apr. 28, 2020 (CN) 202010348530.0

(51) Int. Cl. G06F 3/0488; G06F 3/0482; G06F 3/01

(52) U.S. Cl. CPC G06F 3/0488; G06F 3/017; G06F 3/0482

(57) ABSTRACT

In aspects of temporarily extending display timeout, a wireless device has a touchscreen display that displays content and is designed to turn off after a designated period of time for a screen lock timeout. The wireless device implements a display controller module that can detect an input on the touchscreen display, and determine the input as an override of the screen lock timeout to maintain the display of the content. The display controller module can then extend the screen lock timeout for a temporary time duration based on the override to maintain the display of the content. The display controller module can also revert back to the designated period of time for the screen lock timeout after expiration of the temporary time duration.

### RELATED APPLICATION

This application claims the priority benefit of China Patent Application for Invention Serial No. 202010348530.0 filed Apr. 28, 2020 entitled “Temporarily Extending Display Timeout”, the disclosure of which is incorporated by reference herein in its entirety.

### BACKGROUND

Devices such as smart devices, mobile devices (e.g., cellular phones, tablet devices, smartphones), consumer electronics, and the like can be implemented for use in a wide range of environments and for a variety of different applications. Many different types of these wireless devices, such as mobile phones, have a touchscreen display to display many different types of digital content and media in application interfaces. In various situations, a user of mobile phone or other type of device may want to allow another person to look at the displayed content on the device display. For example, a user of a mobile phone may want to hand the device to another person, such as a bank teller, hotel reservation agent, or other service counter person who can then view information that is shown on the device display. Often, however, these devices have a screen lock timeout that will turn off and lock the device display after a designated time duration, particularly if the device has been set down, or is being held at an angle that does not activate a “keep alive” function, such as if the camera of the device does not detect a person looking at the device, or if the person who is viewing the information on the device does not repeatedly touch the display screen to keep it active.

### BRIEF DESCRIPTION OF THE DRAWINGS

Implementations of the techniques for temporarily extending display timeout are described with reference to the following Figures. The same numbers may be used throughout to reference like features and components shown in the Figures:

FIG. 1 illustrates an example of techniques for temporarily extending display timeout on a wireless device in accordance with one or more implementations as described herein.

FIG. 2 illustrates another example of the techniques for temporarily extending display timeout on the wireless device in accordance with one or more implementations as described herein.

FIG. 3 illustrates an example method of temporarily extending display timeout in accordance with one or more implementations of the techniques described herein.

FIG. 4 illustrates an example method of temporarily extending display timeout in accordance with one or more implementations of the techniques described herein.

FIG. 5 illustrates an example method of temporarily extending display timeout in accordance with one or more implementations of the techniques described herein.

FIG. 6 illustrates various components of an example device that can used to implement the techniques for temporarily extending display timeout as described herein.

### DETAILED DESCRIPTION

Implementations of temporarily extending display timeout are described, and provide techniques implemented by a wireless device to receive an input to the device as an override of a screen lock timeout, and extend the screen lock timeout for a temporary time duration. Generally, the wireless device may be a mobile phone (also commonly referred to as a “smartphone”) that has a touchscreen display which can display any type of digital content and various media for viewing by a user of the device. The features of temporarily extending display timeout provide for a quick user interaction to temporarily extend the screen lock timeout, such as when a user of the wireless device wants to pass the device to another person who may need to view information displayed on the device.

For example, the user may pass the device to a bank teller, a service counter person, or a hotel reservation agent who is looking at reservation information on the device touchscreen display and typing in the hotel computer system to pull up and verify the reservation. However, the touchscreen display that displays the information may be designed to turn off after a designated period of time for a screen lock timeout. Depending on user settings, the wireless device may have a relatively short screen lock timeout (e.g., after 15 or 30 seconds). The person who has been passed the device may need the information to remain displayed for viewing on the touchscreen display for longer than the screen lock timeout designated period of time. Additionally, the wireless device may have been set down on the counter, or is being held at an angle that does not activate a “keep alive” function, such as if the camera of the wireless device does not detect a person looking at the device, or if the person who is viewing the information on the device does not repeatedly touch the screen to keep it active.

In aspects of temporarily extending display timeout as described herein, the wireless device implements a display controller module that can detect a touch input on the touchscreen display of the device. The touch input on the touchscreen display can be detected as any type of gesture and/or swipe input across the display, or as any type of a touch selection of a user interface control feature. The display controller module can then determine the touch input as a timeout override of the screen lock timeout to maintain the content display on the touchscreen display. In implementations, the user of the wireless device can initiate the timeout override of the screen lock timeout with a swipe gesture across the touchscreen display of the device, and the touch input (e.g., the swipe gesture) is received by the display controller module and determined as the timeout override. The swipe gesture can be detected as being initiated by the user with a thumb and index finger moving across the touchscreen display in a direction generally from the bottom toward the top of the touchscreen display on the device.

Further, the display controller module can determine the touch input as the timeout override of the screen lock timeout, and extend the screen lock timeout for a temporary time duration based on the override to maintain the content display on the touchscreen display of the device. An override indication may also be displayed on the touchscreen display to provide user feedback and indicate that the override of the screen lock timeout has been activated for the temporary time duration. In implementations, the display controller module may also receive an additional input as detected on the touchscreen display, and can then continue to extend the screen lock timeout for another temporary time duration subsequent to the first temporary time duration. Similarly, the display controller module may receive an input that is detected on the touchscreen display as two (or more) consecutive swipe gestures across the touchscreen display. The display controller module can then extend the screen lock timeout for twice the temporary time duration (or more) based on the input of the consecutive swipe gestures to initiate the timeout override of the screen lock timeout and maintain the content display.

In other aspects of temporarily extending display timeout as described herein, the display controller module can revert back to the designated period of time for the screen lock timeout after expiration of the temporary time duration to extend the timeout override. This feature provides that the user of the wireless device does not have to first navigate to the device settings and extend the time setting for the screen lock timeout before passing the device to another person who may need to view displayed information, and then after receiving the device back from the person, having to again navigate to the device settings and reset the screen lock timeout setting to the previous, shorter time duration.

While features and concepts of temporarily extending display timeout can be implemented in any number of different devices, systems, environments, and/or configurations, implementations of temporarily extending display timeout are described in the context of the following example devices, systems, and methods.

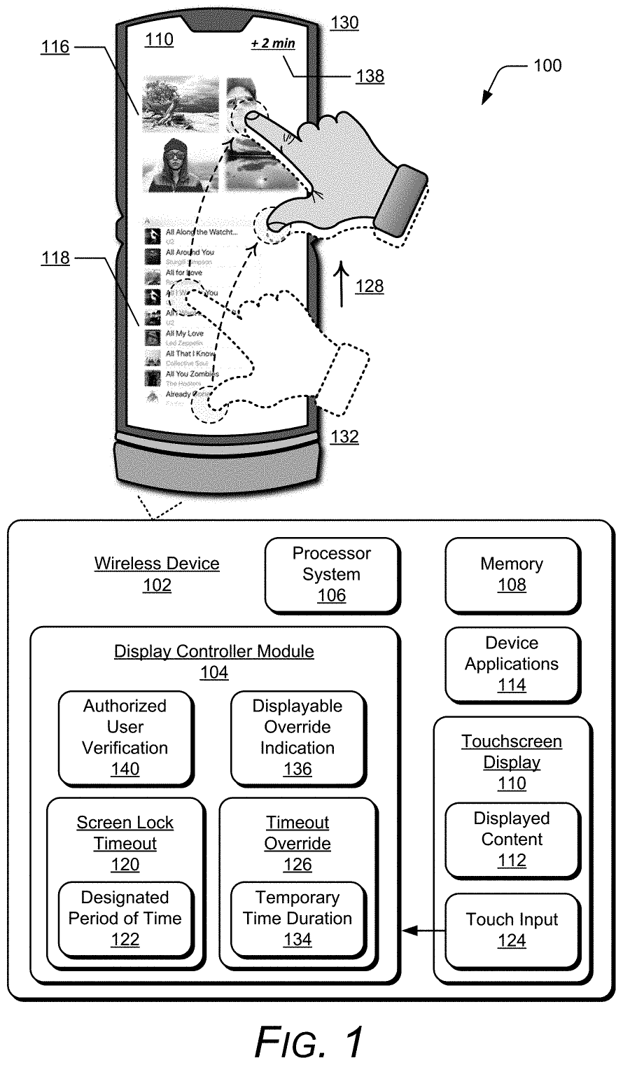

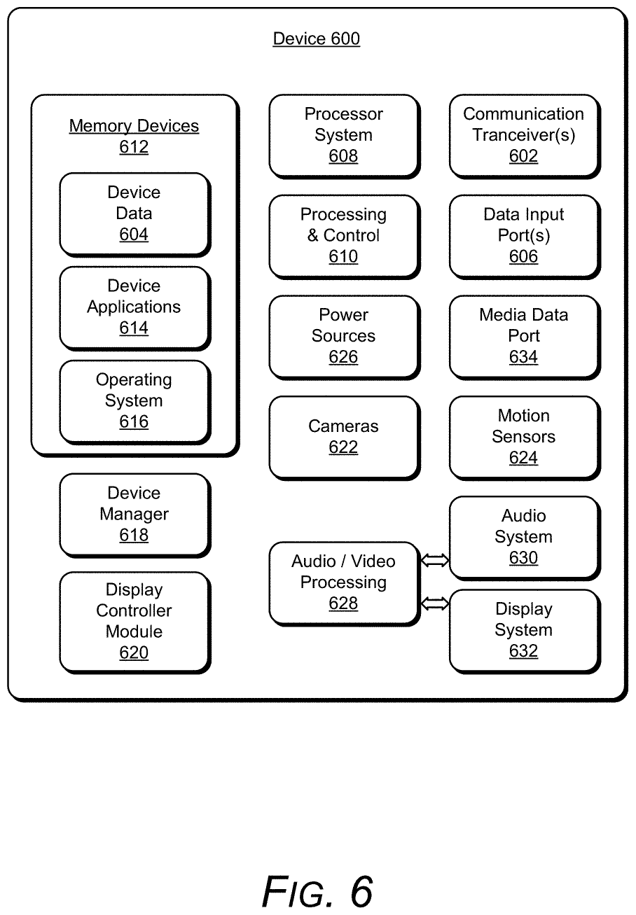

FIG. 1 illustrates an example 100 of techniques for temporarily extending display timeout using a wireless device 102 that implements a display controller module 104, which determines an input to the device as an override of a screen lock timeout, and extends the screen lock timeout for a temporary time duration. In this example 100, the wireless device 102 may be any type of a mobile device, tablet device, computing device, mobile phone, flip phone, and/or any other type of wireless device. Generally, the wireless device 102 may be any type of an electronic, wireless, and/or computing device implemented with various components, such as a processor system 106 and memory 108, as well as any number and combination of different components as further described with reference to the example device shown in FIG. 6.

In implementations, the wireless device 102 may be a mobile phone (also commonly referred to as a “smartphone”) that has a touchscreen display 110 which can display any type of content 112 (e.g., digital content and media) for viewing by a user of the device. Generally, the wireless device 102 includes device applications 114, such as any type of user and/or device applications that are executable on the device, and the device applications have user interfaces through which the content 112 is displayed on the touchscreen display 110 of the device. For example, the device applications 114 can include a photo application that a user of the wireless device 102 may initiate to display digital photos 116 that are stored in the memory 108 on the device. Similarly, the device applications 114 can include a music and other digital media playback application that includes a media content user interface 118 displayed on the touchscreen display 110 of the device. If several of the device applications 114 have an associated user interface being displayed on the touchscreen display 110, such as shown in this example 100, then the content that is displayed on the touchscreen display may include content that is of a primary display focus, and other content that is of a secondary display focus.

Notably, the user of the wireless device 102 may want to pass the device to another person who may need to view information displayed on the device, such as a bank teller, a service counter person, or a hotel reservation agent who is looking at reservation information on the device touchscreen display 110 and typing in the hotel computer system to pull up and verify the reservation. However, the touchscreen display 110 that displays the content 112 may be designed to turn off after a designated period of time for a screen lock timeout 120. Depending on user settings, the wireless device 102 may typically have a relatively short screen lock timeout 120, such as for a designated period of time 122 (e.g., 15 seconds or 30 seconds). The person who has been passed the device may need the displayed content 112 to remain displayed for viewing on the touchscreen display 110 for longer than the screen lock timeout designated period of time. Additionally, the wireless device 102 may have been set down on the counter, or is being held at an angle that does not activate a “keep alive” function, such as if the camera of the wireless device does not detect a person looking at the device, or if the person who is viewing the information on the device does not repeatedly touch the screen to keep it active.

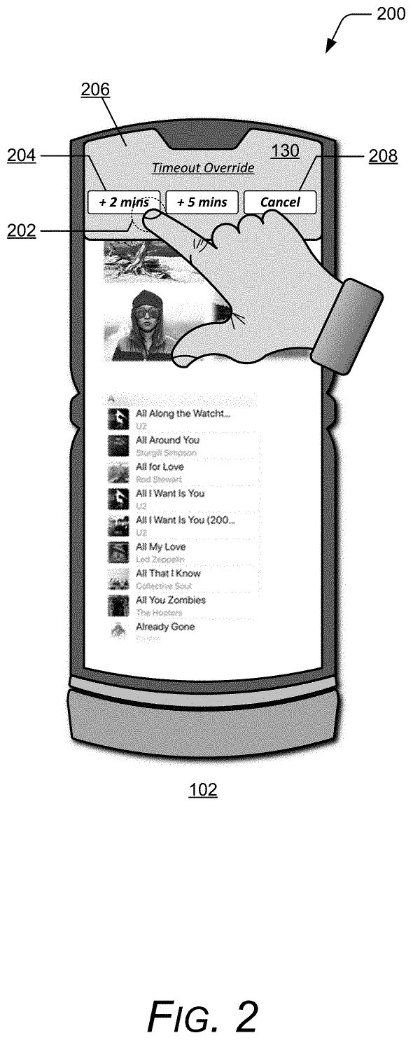

In this example 100, the wireless device 102 includes the display controller module 104 that implements features of temporarily extending display timeout, as described herein and generally as shown and described with reference to FIGS. 1 and 2. The display controller module 104 may be implemented as a module that includes independent processing, memory, and/or logic components functioning as a computing and/or electronic device integrated with the wireless device 102. Alternatively or in addition, the display controller module 104 can be implemented as a software application or software module, such as integrated with an operating system and as computer-executable software instructions that are executable with a processor (e.g., with the processor system 106) of the wireless device 102. As a software application or module, the display controller module 104 can be stored on computer-readable storage memory (e.g., the memory 108 of the device), or in any other suitable memory device or electronic data storage implemented with the display controller module. Alternatively or in addition, the display controller module 104 may be implemented in firmware and/or at least partially in computer hardware. For example, at least part of the display controller module 104 may be executable by a computer processor, and/or at least part of the display controller module may be implemented in logic circuitry.

In implementations of temporarily extending display timeout, the display controller module 104 can detect a touch input 124 on the touchscreen display 110 of the wireless device 102. The touch input 124 on the touchscreen display 110 can be detected as any type of gesture and/or swipe input on the touchscreen display, or as any type of a touch selection of a user interface control feature. The display controller module 104 can then determine the touch input 124 as a timeout override 126 of the screen lock timeout 120 to maintain the display of the content 112 on the touchscreen display. In some instances, such as shown in this example 100, the displayed content 112 on the touchscreen display 110 may include content that is of a primary display focus, and other content that is of a secondary display focus. As noted above, more than one of the device applications 114 may have an associated user interface being displayed on the touchscreen display 110. The display controller module 104 may be implemented to then extend the screen lock timeout 120 for the temporary time duration 134 to display only the content that is of the primary display focus.

As shown in this example 100, a user can initiate the timeout override 126 of the screen lock timeout 120 with a swipe gesture 128 on the touchscreen display 110 of the wireless device. The touch input 124 on the touchscreen display is detected as the swipe gesture 128, which is received by the display controller module 104 and determined as the timeout override 126. In implementations, the swipe gesture 128 is detected as moving across the touchscreen display 110 in a direction generally toward a top 130 of the touchscreen display or device, such as when the swipe gesture is initiated near the bottom 132 of the touchscreen display or device and the user swipes up across the display. Additionally, the swipe gesture 128 across the touchscreen display 110 can be detected as being initiated by the user with a thumb and index finger moving in the direction toward the top 130 of the touchscreen display or device, such as shown in this example 100.

The display controller module 104 can determine the touch input 124 as the timeout override 126 of the screen lock timeout 120, and extend the screen lock timeout for a temporary time duration 134 based on the override to maintain the display of the content 112 on the touchscreen display. The display controller module 104 can also initiate to display an override indication 136 of the temporary time duration 134 on the touchscreen display 110, such as the added time indication 138 that is displayed to provide feedback to a user of the device to indicate that the override of the screen lock timeout has been activated and for the temporary time duration.

In implementations, the display controller module 104 may also receive an additional input (e.g., another touch input 124) as detected on the touchscreen display 110 to continue the timeout override 126 of the screen lock timeout 120. The display controller module 104 can then continue to extend the screen lock timeout for another temporary time duration subsequent to the first temporary time duration. Similarly, the display controller module 104 may receive an input that is detected on the touchscreen display 110 as two (or more) consecutive swipe gestures 128 across the touchscreen display. The display controller module 104 can then extend the screen lock timeout 120 for twice the temporary time duration 134 (or more) based on the input of the two consecutive swipe gestures determined as the timeout override 126 of the screen lock timeout 120 to maintain the display of the content 112.

In aspects of temporarily extending display timeout, the display controller module 104 may also be implemented to receive an authorized user verification 140 that indicates an authorized user of the wireless device 102 in conjunction with the detection of the touch input 124 on the touchscreen display 110 of the device. For example, the verification 140 of the authorized user of the wireless device 102 may be based on any type of biometric verification, such as from facial recognition of the user or other similar “keep alive” settings of the device. This is an optional security feature to ensure that the touch input 124 (e.g., received as the swipe gesture 128) is being initiated by an authorized user of the device to extend and maintain the displayed content 112 on the touchscreen display 110 of the device. The screen lock timeout 120 can then be extended by the display controller module 104 for the temporary time duration 134 based on the determination of the timeout override 126 and the verification 140 of the authorized user.

In other aspects, the display controller module 104 can revert back to the designated period of time 122 for the screen lock timeout 120 after expiration of the temporary time duration 134 (and after subsequent, consecutive temporary time durations) of the timeout override 126. This feature provides that the user of the wireless device 102 does not have to first navigate to the device settings and extend the designated period of time 122 for the screen lock timeout 120 before passing the device to another person who may need to view displayed information, and then after receiving the device back from the person, having to again navigate to the device settings and reset the screen lock timeout setting to the previous, shorter time duration.

FIG. 2 illustrates another example 200 of techniques for temporarily extending display timeout using the wireless device 102 that implements the display controller module 104, which determines an input to the device as an override of the screen lock timeout 120, and extends the screen lock timeout for the temporary time duration 134 to maintain the content 112 being displayed on the touchscreen display 110 of the device. In this example 200 of an alternate implementation, the display controller module 104 can receive the touch input 124 that is detected on the touchscreen display 110 as a touch selection 202 of a user interface control feature 204 in a drop-down menu 206. A user of the wireless device 102 can swipe down from the top 130 of the touchscreen display 110 to pull down and reveal the drop-down menu 206 (also referred to as a drop-down curtain or menu bar). The display controller module 104 can then receive the user touch selection on the touchscreen display 110 as a drop-down menu selection to initiate the timeout override 126 of the screen lock timeout 120.

In this example 200, the user of the wireless device 102 is shown to select and initiate a two-minute timeout override (“+2 mins”) as the drop-down menu selection on the drop-down menu 206. The user could also initially and/or consecutively select a five-minute timeout override (“+5 mins”) from the drop-down menu 206. Additionally, the user of the wireless device 102 can initiate to cancel the timeout override 126 by selecting the “cancel” user interface control feature 208. The display controller module 104 can receive the cancel input and for security and/or privacy control, and revert back to the designated period of time 122 for the screen lock timeout 120, such as before expiration of the temporary time duration 134.

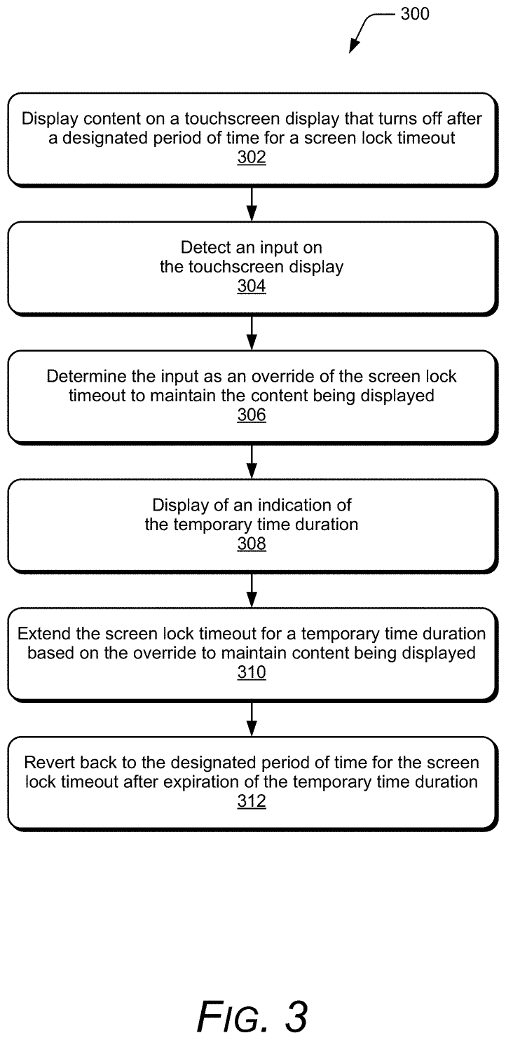

Example methods 300, 400, and 500 are described with reference to respective FIGS. 3, 4, and 5 in accordance with implementations of temporarily extending display timeout. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 of temporarily extending display timeout, and is generally described with reference to display controller module implemented by a wireless device. The order in which the method is described is not intended to be construed as a limitation, and any number or combination of the described method operations can be performed in any order to perform a method, or an alternate method.

At 302, content is displayed on a touchscreen display that turns off after a designated period of time for a screen lock timeout. For example, the wireless device 102 has the touchscreen display 110 which can display any type of content 112 (e.g., digital content and media) for viewing by a user of the device, and the displayed content 112 may include content that is of a primary display focus, and other content that is of a secondary display focus. Generally, the touchscreen display 110 is implemented to turn off after the designated period of time 122 for the screen lock timeout 120.

At 304, an input is detected on the touchscreen display. For example, the display controller module 104 that is implemented by the wireless device 102 can detect a touch input 124 on the touchscreen display 110 of the wireless device 102, such as any type of gesture and/or swipe input on the touchscreen display, or as any type of a touch selection of a user interface control feature. In implementations, the display controller module 104 can detect the touch input 124 on the touchscreen display as the swipe gesture 128 that moves across the touchscreen display in a direction generally toward the top 130 of the touchscreen display. The display controller module 104 can detect the swipe gesture 128 across the touchscreen display 110 as being initiated by the user with a thumb and index finger moving in the direction toward the top 130 of the touchscreen display. Additionally, the display controller module 104 may receive an input that is detected on the touchscreen display 110 as two (or more) consecutive swipe gestures 128 across the touchscreen display.

At 306, the input is determined as an override of the screen lock timeout to maintain the content being displayed. For example, the display controller module 104 that is implemented by the wireless device 102 can determine the touch input 124 as a timeout override 126 of the screen lock timeout 120 to maintain the display of the content 112 on the touchscreen display.

At 308, an indication of the temporary time duration is displayed. For example, the display controller module 104 that is implemented by the wireless device 102 can initiate to display the override indication 136 of the temporary time duration 134 on the touchscreen display 110, such as the added time indication 138 (shown as “+2 min”) which is displayed to provide user feedback, indicating that the timeout override 126 of the screen lock timeout 120 has been activated and for the temporary time duration.

At 310, the screen lock timeout is extended for a temporary time duration based on the override to maintain content being displayed. For example, the display controller module 104 that is implemented by the wireless device 102 can extend the screen lock timeout 120 for the temporary time duration 134 based on the override to maintain the display of the content 112 on the touchscreen display 110. As noted above, more than one of the device applications 114 may have an associated user interface being displayed on the touchscreen display 110, and the display controller module 104 can extend the screen lock timeout 120 for the temporary time duration 134 to display only the content that is of the primary display focus. Additionally, the display controller module 104 can extend the screen lock timeout 120 for twice the temporary time duration based on an input of two consecutive swipe gestures 128 across the touchscreen display that are determined as the timeout override 126 of the screen lock timeout 120 to maintain the displayed content.

At 312, the screen lock timeout is reverted back to the designated period of time after expiration of the temporary time duration. For example, the display controller module 104 that is implemented by the wireless device 102 can revert back to the designated period of time 122 for the screen lock timeout 120 after expiration of the temporary time duration 134 (and after subsequent, consecutive temporary time durations) of the timeout override 126.

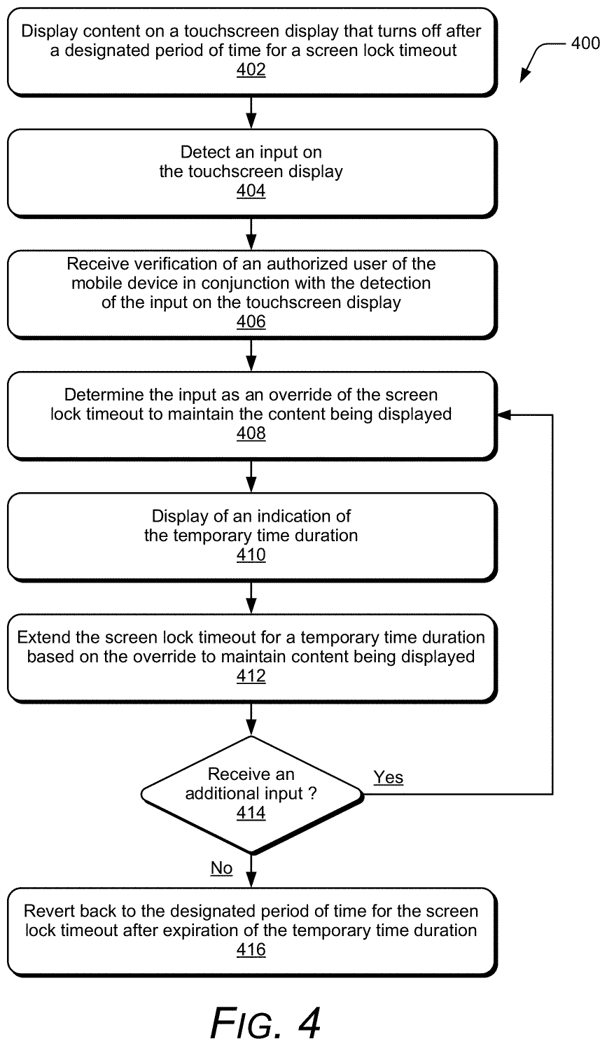

FIG. 4 illustrates example method(s) 400 of temporarily extending display timeout, and is generally described with reference to display controller module implemented by a wireless device. The order in which the method is described is not intended to be construed as a limitation, and any number or combination of the described method operations can be performed in any order to perform a method, or an alternate method.

At 402, content is displayed on a touchscreen display that turns off after a designated period of time for a screen lock timeout. For example, the wireless device 102 has the touchscreen display 110 which can display any type of content 112 (e.g., digital content and media) for viewing by a user of the device, and the displayed content 112 may include content that is of a primary display focus, and other content that is of a secondary display focus. Generally, the touchscreen display 110 is implemented to turn off after the designated period of time 122 for the screen lock timeout 120.

At 404, an input is detected on the touchscreen display. For example, the display controller module 104 that is implemented by the wireless device 102 can detect a touch input 124 on the touchscreen display 110 of the wireless device 102, such as any type of gesture and/or swipe input on the touchscreen display, or as any type of a touch selection of a user interface control feature. In implementations, the display controller module 104 can detect the touch input 124 on the touchscreen display as the swipe gesture 128 that moves across the touchscreen display in a direction generally toward the top 130 of the touchscreen display. The display controller module 104 can detect the swipe gesture 128 across the touchscreen display 110 as being initiated by the user with a thumb and index finger moving in the direction toward the top 130 of the touchscreen display. Additionally, the display controller module 104 may receive an input that is detected on the touchscreen display 110 as two (or more) consecutive swipe gestures 128 across the touchscreen display.

At 406, verification of an authorized user of the wireless device is received in conjunction with the detection of the input on the touchscreen display. For example, the display controller module 104 that is implemented by the wireless device 102 can receive an authorized user verification 140 that indicates an authorized user of the wireless device 102 in conjunction with the detection of the touch input 124 on the touchscreen display 110 of the device. The verification 140 of the authorized user of the wireless device 102 may be based on any type of biometric verification, such as from facial recognition of the user or other similar “keep alive” settings of the device. This security feature can be implemented to ensure that the touch input 124 (e.g., received as the swipe gesture 128) is being initiated by an authorized user of the device to extend and maintain the displayed content 112 on the touchscreen display 110 of the device.

At 408, the input is determined as an override of the screen lock timeout to maintain the content being displayed. For example, the display controller module 104 that is implemented by the wireless device 102 can determine the touch input 124 as a timeout override 126 of the screen lock timeout 120 to maintain the display of the content 112 on the touchscreen display.

At 410, an indication of the temporary time duration is displayed. For example, the display controller module 104 that is implemented by the wireless device 102 can initiate to display the override indication 136 of the temporary time duration 134 on the touchscreen display 110, such as the added time indication 138 (shown as “+2 min”) which is displayed to provide user feedback, indicating that the timeout override 126 of the screen lock timeout 120 has been activated and for the temporary time duration.

At 412, the screen lock timeout is extended for a temporary time duration based on the override to maintain content being displayed. For example, the display controller module 104 that is implemented by the wireless device 102 can extend the screen lock timeout 120 for the temporary time duration 134 based on the determination of the override and the verification of the authorized user to maintain the displayed content 112 on the touchscreen display 110 of the device.

At 414, a determination is made as to whether an additional input is received to continue the override of the screen lock timeout. For example, the display controller module 104 that is implemented by the wireless device 102 can detect another touch input on the touchscreen display 110 of the wireless device 102, such as another swipe gesture 128 that moves across the touchscreen display in a direction generally toward the top 130 of the touchscreen display. If an additional input is received to continue the override of the screen lock timeout 120 (i.e., “Yes” from 414), then the method continues at 408-412 to continue extending the screen lock timeout for another temporary time duration subsequent to the first temporary time duration.

If an additional input is not received as detected by the display controller module 104 on the touchscreen display 110 of the wireless device 102 (i.e., “No” from 414), then at 416, the screen lock timeout is reverted back to the designated period of time after expiration of the temporary time duration. For example, the display controller module 104 that is implemented by the wireless device 102 can revert back to the designated period of time 122 for the screen lock timeout 120 after expiration of the temporary time duration 134 (and after subsequent, consecutive temporary time durations) of the timeout override 126.

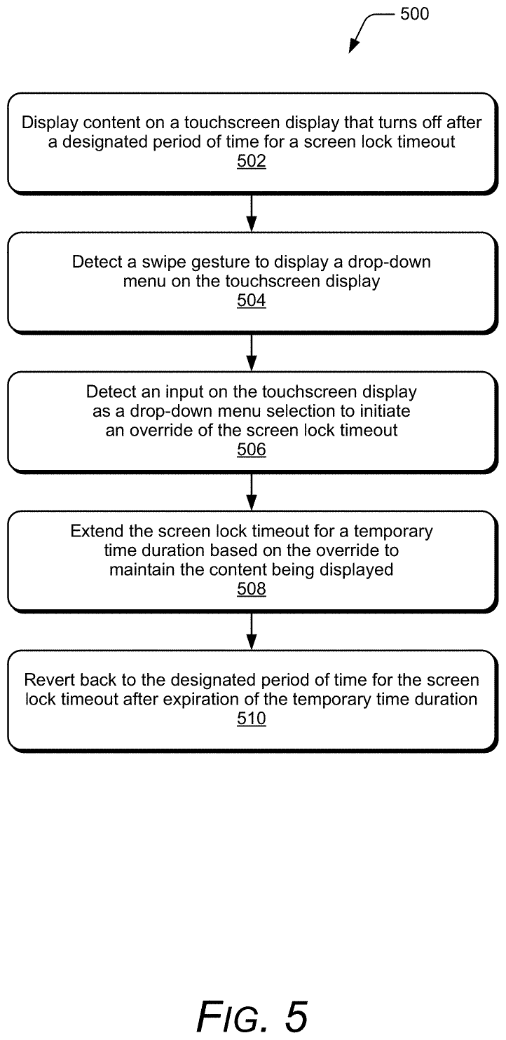

FIG. 5 illustrates example method(s) 500 of temporarily extending display timeout, and is generally described with reference to display controller module implemented by a wireless device. The order in which the method is described is not intended to be construed as a limitation, and any number or combination of the described method operations can be performed in any order to perform a method, or an alternate method.

At 502, content is displayed on a touchscreen display that turns off after a designated period of time for a screen lock timeout. For example, the wireless device 102 has the touchscreen display 110 which can display any type of content 112 (e.g., digital content and media) for viewing by a user of the device, and the displayed content 112 may include content that is of a primary display focus, and other content that is of a secondary display focus. Generally, the touchscreen display 110 is implemented to turn off after the designated period of time 122 for the screen lock timeout 120.

At 504, a swipe gesture is detected to display a drop-down menu on the touchscreen display. For example, the display controller module 104 that is implemented by the wireless device 102 can detect a swipe down gesture from the top 130 of the touchscreen display 110 to pull down and reveal the drop-down menu 206 on the touchscreen display of the wireless device.

At 506, an input is detected on the touchscreen display as a drop-down menu selection to initiate an override of the screen lock timeout. For example, the display controller module 104 that is implemented by the wireless device 102 can receive the touch input 124 that is detected on the touchscreen display 110 as the touch selection 202 of the user interface control feature 204 in the drop-down menu 206. The display controller module 104 can receive the drop-down menu selection to initiate the timeout override 126 of the screen lock timeout 120 and maintain the content being displayed on the touchscreen display of the device.

At 508, the screen lock timeout is extended for a temporary time duration based on the override to maintain the content being displayed. For example, the display controller module 104 that is implemented by the wireless device 102 can extend the screen lock timeout 120 for the temporary time duration 134 based on the determination of the override to maintain the displayed content 112 on the touchscreen display 110 of the device.

At 510, the screen lock timeout is reverted back to the designated period of time after expiration of the temporary time duration. For example, the display controller module 104 that is implemented by the wireless device 102 can revert back to the designated period of time 122 for the screen lock timeout 120 after expiration of the temporary time duration 134 (and after subsequent, consecutive temporary time durations) of the timeout override 126.

FIG. 6 illustrates various components of an example device 600, in which aspects of temporarily extending display timeout can be implemented. The example device 600 can be implemented as any of the devices described with reference to the previous FIGS. 1-5, such as any type of a wireless device, mobile device, mobile phone, flip phone, client device, companion device, paired device, display device, tablet, computing, communication, entertainment, gaming, media playback, and/or any other type of computing and/or electronic device. For example, the wireless device 102 described with reference to FIGS. 1 and 2 may be implemented as the example device 600.

The device 600 includes communication transceivers 602 that enable wired and/or wireless communication of device data 604 with other devices. The device data 604 can include any of the display controller module generated, determined, received, and/or stored data. Additionally, the device data 604 can include any type of audio, video, and/or image data. Example communication transceivers 602 include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication. The example device 600 can be implemented for data communication between devices and network systems, which may include wired and/or wireless networks implemented using any type of network topology and/or communication protocol, to include IP based networks, and/or the Internet, as well as networks that are managed by mobile network operators, such as a communication service providers, mobile phone providers, and/or Internet service providers.

The device 600 may also include one or more data input ports 606 via which any type of data, media content, and/or inputs can be received, such as user-selectable inputs to the device, communications, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 600 includes a processor system 608 of one or more processors (e.g., any of microprocessors, controllers, and the like) and/or a processor and memory system implemented as a system-on-chip (SoC) that processes computer-executable instructions. The processor system may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 610. The device 600 may further include any type of a system bus or other data and command transfer system that couples the various components within the device. A system bus can include any one or combination of different bus structures and architectures, as well as control and data lines.

The device 600 also includes memory and/or memory devices 612 (e.g., computer-readable storage memory) that enable data storage, such as data storage devices that can be accessed by a computing device, and that provide persistent storage of data and executable instructions (e.g., software applications, programs, functions, and the like). Examples of the memory devices 612 include volatile memory and non-volatile memory, fixed and removable media devices, and any suitable memory device or electronic data storage that maintains data for computing device access. The memory devices 612 can include various implementations of random access memory (RAM), read-only memory (ROM), flash memory, and other types of storage media in various memory device configurations. The device 600 may also include a mass storage media device.

The memory devices 612 (e.g., as computer-readable storage memory) provide data storage mechanisms to store the device data 604, other types of information and/or data, and various device applications 614 (e.g., software applications and/or modules). For example, an operating system 616 can be maintained as software instructions with a memory device and executed by the processor system 608. The device applications 614 may also include a device manager 618, such as any form of a control application, software application, signal-processing and control module, code that is specific to a particular device, a hardware abstraction layer for a particular device, and so on.

In this example, the device 600 includes a display controller module 620 that implements aspects of temporarily extending display timeout. The display controller module 620 may be implemented with hardware components and/or in software as one of the device applications 614, such as when the device 600 is implemented as the wireless device 102 described with reference to FIGS. 1 and 2. Examples of the display controller module 620 includes the display controller module 104 that is implemented by the wireless device 102, such as a software application and/or as hardware components in the wireless device. In implementations, the display controller module 620 may include independent processing, memory, and logic components as a computing and/or electronic device integrated with the example device 600.

In this example, the device 600 can also include cameras 622 and motion sensors 624, such as may be implemented as components of an inertial measurement unit (IMU). The motion sensors 624 can be implemented with various sensors, such as a gyroscope, an accelerometer, and/or other types of motion sensors to sense motion of the device. The motion sensors 624 can generate sensor data vectors having three-dimensional parameters (e.g., rotational vectors in x, y, and z-axis coordinates) indicating location, position, acceleration, rotational speed, and/or orientation of the device. The device 600 can also include one or more power sources 626, such as when the device is implemented as a wireless device and/or mobile device. The power sources may include a charging and/or power system, and can be implemented as a flexible strip battery, a rechargeable battery, a charged super-capacitor, and/or any other type of active or passive power source.

The device 600 can also include an audio and/or video processing system 628 that generates audio data for an audio system 630 and/or generates display data for a display system 632. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as via media data port 634. In implementations, the audio system and/or the display system are integrated components of the example device. Alternatively, the audio system and/or the display system are external, peripheral components to the example device.

Although implementations of temporarily extending display timeout have been described in language specific to features and/or methods, the subject of the appended claims is not necessarily limited to the specific features or methods described. Rather, the specific features and methods are disclosed as example implementations of temporarily extending display timeout, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

A wireless device, comprising: a touchscreen display configured to display content and turn off after a designated period of time for a screen lock timeout; a display controller module implemented at least partially in computer hardware to: detect an input on the touchscreen display; determine the input as an override of the screen lock timeout to maintain the display of the content; and extend the screen lock timeout for a temporary time duration based on the override to maintain the display of the content.

Alternatively or in addition to the above described wireless device, any one or combination of: the display controller module is configured to revert back to the designated period of time for the screen lock timeout after expiration of the temporary time duration. The display controller module is configured to receive verification of an authorized user of the wireless device in conjunction with the detection of the input on the touchscreen display, and extend the screen lock timeout for the temporary time duration based on the determination of the override and the verification of the authorized user. The display controller module is configured to detect the input as a swipe gesture across the touchscreen display moving in a direction toward a top of the touchscreen display. The display controller module is configured to detect the swipe gesture across the touchscreen display being initiated with a thumb and index finger moving in the direction toward the top of the touchscreen display. The content includes a primary display focus and at least a secondary display focus, and the display controller module is configured to extend the screen lock timeout for the content that is the primary display focus. The display controller module is configured to receive an additional input to continue the override of the screen lock timeout, and continue to extend the screen lock timeout for another temporary time duration subsequent to the temporary time duration. The display controller module is configured to detect the input as two consecutive swipe gestures across the touchscreen display, and extend the screen lock timeout for twice the temporary time duration based on the input of the two consecutive swipe gestures determined as the override of the screen lock timeout to maintain the display of the content. The display controller module is configured to initiate a display of an indication of the temporary time duration. The display controller module is configured to detect the input as a drop-down menu selection to initiate the override of the screen lock timeout.

A method, comprising: displaying content on a touchscreen display that turns off after a designated period of time for a screen lock timeout; detecting an input on the touchscreen display; determining the input as an override of the screen lock timeout to maintain the displaying of the content; extending the screen lock timeout for a temporary time duration based on the override to maintain the displaying of the content; and reverting back to the designated period of time for the screen lock timeout after expiration of the temporary time duration.

Alternatively or in addition to the above described method, any one or combination of: the input is detected as a swipe gesture across the touchscreen display moving in a direction toward a top of the touchscreen display. The method further comprising receiving an additional input to continue the override of the screen lock timeout, and continuing to extend the screen lock timeout for another temporary time duration subsequent to the temporary time duration. The input is detected as two consecutive swipe gestures across the touchscreen display, and the screen lock timeout is extended for twice the temporary time duration based on the input of the two consecutive swipe gestures determined as the override of the screen lock timeout to maintain the displaying of the content. The method further comprising displaying of an indication of the temporary time duration. The input is detected as a drop-down menu selection to initiate the override of the screen lock timeout.

A display system, comprising: a touchscreen display to display content; a screen lock timeout to turn off the touchscreen display after a designated period of time; a display controller module configured to: detect an input on the touchscreen display as an override of the screen lock timeout to maintain the display of the content; and extend the screen lock timeout for a temporary time duration based on the override to maintain the display of the content.

Alternatively or in addition to the above described display system, any one or combination of: the screen lock timeout reverts back to the designated period of time after expiration of the temporary time duration. The input is detected as a swipe gesture across the touchscreen display moving in a direction toward a top of the touchscreen display. The display controller module is configured to detect an additional input to extend the override of the screen lock timeout for another temporary time duration.

1. A wireless device, comprising:
a touchscreen display configured to display content and turn off after a designated period of time for a screen lock timeout;
a display controller module implemented at least partially in computer hardware to:
detect an input on the touchscreen display;
determine the input as an override of the screen lock timeout to maintain the display of the content; receive verification that the input to override the screen lock timeout was initiated by an authorized user of the wireless device; and
extend the screen lock timeout for a temporary time duration based on the override to maintain the display of the content and the verification of the authorized user.

2. The wireless device as recited in claim 1, wherein the display controller module is configured to revert back to the designated period of time for the screen lock timeout after expiration of the temporary time duration.

3. (canceled)

4. The wireless device as recited in claim 1, wherein the display controller module is configured to detect the input as a swipe gesture across the touchscreen display moving in a direction toward a top of the touchscreen display.

5. The wireless device as recited in claim 4, wherein the display controller module is configured to detect the swipe gesture across the touchscreen display being initiated with a thumb and index finger moving in the direction toward the top of the touchscreen display.

6. The wireless device as recited in claim 1, wherein:
the content includes a primary display focus and at least a secondary display focus; and
the display controller module is configured to extend the screen lock timeout for the content that is the primary display focus.

7. The wireless device as recited in claim 1, wherein the display controller module is configured to:
receive an additional input to continue the override of the screen lock timeout; and
continue to extend the screen lock timeout for another temporary time duration subsequent to the temporary time duration.

8. The wireless device as recited in claim 1, wherein the display controller module is configured to:
detect the input as two consecutive swipe gestures across the touchscreen display; and
extend the screen lock timeout for twice the temporary time duration based on the input of the two consecutive swipe gestures determined as the override of the screen lock timeout to maintain the display of the content.

9. The wireless device as recited in claim 1, wherein the display controller module is configured to initiate a display of an indication of the temporary time duration.

10. The wireless device as recited in claim 1, wherein the display controller module is configured to detect the input as a drop-down menu selection to initiate the override of the screen lock timeout.

11. A method, comprising:
displaying content on a touchscreen display of a wireless device that turns off after a designated period of time for a screen lock timeout;
detecting an input on the touchscreen display;
determining the input as an override of the screen lock timeout to maintain the displaying of the content;
receiving verification that the input to override the screen lock timeout was initiated by an authorized user of the wireless device;
extending the screen lock timeout for a temporary time duration based on the override to maintain the displaying of the content and the verification of the authorized user; and
reverting back to the designated period of time for the screen lock timeout after expiration of the temporary time duration.

12. The method as recited in claim 11, wherein the input is detected as a swipe gesture across the touchscreen display moving in a direction toward a top of the touchscreen display.

13. The method as recited in claim 11, further comprising:
receiving an additional input to continue the override of the screen lock timeout; and
continuing to extend the screen lock timeout for another temporary time duration subsequent to the temporary time duration.

14. The method as recited in claim 11, wherein:
the input is detected as two consecutive swipe gestures across the touchscreen display; and
the screen lock timeout is extended for twice the temporary time duration based on the input of the two consecutive swipe gestures determined as the override of the screen lock timeout to maintain the displaying of the content.

15. The method as recited in claim 11, further comprising:
displaying of an indication of the temporary time duration.

16. The method as recited in claim 11, wherein the input is detected as a drop-down menu selection to initiate the override of the screen lock timeout.

17. A display system, comprising:
a touchscreen display to display content;
a screen lock timeout to turn off the touchscreen display after a designated period of time;
a display controller module configured to:
detect an input on the touchscreen display as an override of the screen lock timeout to maintain the display of the content;
receive verification that the input to override the screen lock timeout was initiated by an authorized user of the display system; and
extend the screen lock timeout for a temporary time duration based on the override to maintain the display of the content and the verification of the authorized user.

18. The display system as recited in claim 17, wherein the screen lock timeout reverts back to the designated period of time after expiration of the temporary time duration.

19. The display system as recited in claim 17, wherein the input is detected as a swipe gesture across the touchscreen display moving in a direction toward a top of the touchscreen display.

20. The display system as recited in claim 17, wherein the display controller module is configured to detect an additional input to extend the override of the screen lock timeout for another temporary time duration.

21. The display system as recited in claim 17, wherein the display controller module is configured to detect the input as a drop-down menu selection to initiate the override of the screen lock timeout.
